(19) United States
(12) Patent Application Publication
(10) Pub. No.: US 2021/0092109 A1
(43) Pub. Date: Mar. 25, 2021

(54) SYSTEMS AND METHODS FOR PROTECTING DRONE-TO-GROUND COMMUNICATIONS

(71) Applicant: SkyX Limited, Woodbridge (CA)

(72) Inventors: Jason Braverman, Thornill (CA); Viorel Baicu, Woodbridge (CA)

(21) Appl. No.: 17/032,116

(22) Filed: Sep. 25, 2020

Related U.S. Application Data
(60) Provisional application No. 62/905,672, filed on Sep. 25, 2019.

(51) Int. Cl. H04L 29/06; H04L 9/32

(52) U.S. Cl. CPC H04L 63/0823; B64C 39/024; H04L 9/3231

(57) ABSTRACT

Drone communication with a ground control system can be secured using digital certificates based on authorized user's biometric information. The ground control system can verify a user's biometric information to ensure they are authorized to perform the requested actions based on the digital certificates of the drone.

### CROSS REFERENCE TO RELATED APPLICATIONS

The current application claims priority to U.S. Provisional application Ser. No. 62/905,672 filed Sep. 25, 2019, and entitled “Systems and Methods For Protecting Drone-To-Ground Communications,” the entire contents of which are hereby incorporated by reference in their entirety for all purposes.

### BRIEF DESCRIPTION

The current disclosure relates to the autonomous flight control for drones and in particular to the security of the connection between a drone and an operator or ground systems.

### BACKGROUND

Currently drones systems operate on a variety of communications options. Most controlled systems use a radio frequency remote control system, with the pilot flying the drone from the remote control. These systems operate using simple wireless connections, which may or may not be encrypted. In the case of autonomous systems, the drone uses a cellular, satcom or line of sight radio, which provides an internet protocol data link (IP Link) between the drone and backend systems, providing access to telemetry, flight status and allowing the operator to send commands to the drone. There is no standard for these systems, and each product relies on its own method for protecting the connection, and in some cases there might not be much if anything protecting the IP connection between the ground system and the drone, allowing an attacker to potentially gain control of the remote drone.

### SUMMARY

In accordance with the present disclosure there is provided a drone system comprising a drone having a processor and memory comprising at least one digital certificate generated based on biometric information of an individual authorized to perform one or more actions associated with the drone; a flight control system providing a user interface for controlling the drone, the flight control system configured to: receive from a user an indication of a desired action; request biometric validation from the user; receive biometric information from the user; determine if the received biometric information matches the metric information used to generate the digital certificate of the drone; and if the user is authorized to perform the desired action based on matching biometric information, controlling the drone to perform the desired action.

In accordance with the present disclosure, there is provided a drone system comprising: a flight control system providing a user interface for controlling the drone system, the flight control system comprising a processor and memory storing instructions which when executed by the processor configure the system to: receive biometric information from the user; match the received biometric information to a previously generated user certificate, the user certificate associated with one or more actions the user is authorized to execute; and receive from a user an indication of a desired action; if the user is authorized to perform the desired action based on matching biometric information, encrypt the desired action and transmitting the encrypted action to a drone; a plurality of drones, each drone comprising a processor and memory storing instructions which when executed by the processor configure the drone to: receive an encrypted action from the flight control system; decrypt the encrypted action using a certificate stored on the drone; and execute the decrypted action.

In a further embodiment of the drone system, the certificate is a user's biometric certificate associated with authorized actions, and the drone is further configured to: determine if the decrypted action is one of the authorized actions associated with the user's biometric certificate used to decrypt the received encrypted action.

In a further embodiment of the drone system, certificate used to encrypt the action is a server certificate.

In a further embodiment of the drone system, certificate used to encrypt the action is a user's biometric certificate.

In a further embodiment of the drone system, the flight control system is further configured to encrypt the transmission of the encrypted action to the drone using a server certificate.

In a further embodiment of the drone system, the receiving the indication of the desired action from the user comprises: subsequent to matching the received biometric information to the previously generated user certificate, presenting to the user the one or more actions the user certificate is associated with that the user is authorized to execute; and receiving the indication of the desired action as a user selection from the presented one or more actions.

In a further embodiment of the drone system, receiving the indication of the desired action from the user comprises: receiving the indication of the desired action selected from a plurality of possible actions; and determining if the desired action is one of the one or more actions associated with the user certificate.

In accordance with the present disclosure, there is further provided a method for controlling a drone system, the method comprising: receiving biometric information from the user; matching the received biometric information to a previously generated user certificate, the user certificate associated with one or more actions the user is authorized to execute; and receiving from a user an indication of a desired action; and if the user is authorized to perform the desired action based on matching biometric information, encrypting the desired action and transmitting the encrypted action to a drone.

In a further embodiment, the method further comprises: receiving the encrypted action at the drone; decrypting the encrypted action using a certificate stored on the drone; and executing the decrypted action.

In a further embodiment of the method, the certificate is a user's biometric certificate associated with authorized actions, and the method further comprises: determining if the decrypted action is one of the authorized actions associated with the user's biometric certificate used to decrypt the received encrypted action.

In a further embodiment of the method, certificate used to encrypt the action is a server certificate.

In a further embodiment of the method, certificate used to encrypt the action is a user's biometric certificate.

In a further embodiment, the method encrypting the transmission of the encrypted action to the drone using a server certificate.

In a further embodiment of the method, the receiving the indication of the desired action from the user comprises: subsequent to matching the received biometric information to the previously generated user certificate, presenting to the user the one or more actions the user certificate is associated with that the user is authorized to execute; and receiving the indication of the desired action as a user selection from the presented one or more actions.

In a further embodiment of the method, receiving the indication of the desired action from the user comprises: receiving the indication of the desired action selected from a plurality of possible actions; and determining if the desired action is one of the one or more actions associated with the user certificate.

In accordance with the present disclosure, there is further provided a computer readable medium having instructions stored thereon for configuring one or more computing devices to perform a method for controlling a drone system, the method comprising: receiving biometric information from the user; matching the received biometric information to a previously generated user certificate, the user certificate associated with one or more actions the user is authorized to execute; and receiving from a user an indication of a desired action; and if the user is authorized to perform the desired action based on matching biometric information, encrypting the desired action and transmitting the encrypted action to a drone.

In a further embodiment of the computer readable medium, the method further comprises: receiving the encrypted action at the drone; decrypting the encrypted action using a certificate stored on the drone; and executing the decrypted action.

In a further embodiment of the computer readable medium, the certificate is a user's biometric certificate associated with authorized actions, and the method further comprises: determining if the decrypted action is one of the authorized actions associated with the user's biometric certificate used to decrypt the received encrypted action.

In a further embodiment of the computer readable medium, certificate used to encrypt the action is a server certificate.

In a further embodiment of the computer readable medium, certificate used to encrypt the action is a user's biometric certificate.

In a further embodiment of the computer readable medium, the method further comprises encrypting the transmission of the encrypted action to the drone using a server certificate.

In a further embodiment of the computer readable medium, the receiving the indication of the desired action from the user comprises: subsequent to matching the received biometric information to the previously generated user certificate, presenting to the user the one or more actions the user certificate is associated with that the user is authorized to execute; and receiving the indication of the desired action as a user selection from the presented one or more actions.

In a further embodiment of the computer readable medium, receiving the indication of the desired action from the user comprises: receiving the indication of the desired action selected from a plurality of possible actions; and determining if the desired action is one of the one or more actions associated with the user certificate.

### BRIEF DESCRIPTION OF DRAWINGS

Further features and advantages of the present disclosure will become apparent from the following detailed description, taken in combination with the appended drawings, in which:

FIG. 1 depicts a drone and control system having secured communications using biometrics; and

FIG. 2 depicts a communication and control method for autonomous, or semi-autonomous drones.

### DETAILED DESCRIPTION

Current drone communication and control systems have lax security and do not protect the ground to drone communications from attacks such as replay type attacks or man-in-the-middle type attacks. A remote attacker could potentially impersonate the ground station, spoof its MAC and IP address, and gain control over a drone in flight. While some systems encrypt the information being sent from either side of the connection, they do not necessarily prevent someone from eavesdropping on the connection, recording what is said between each party, and replaying or replacing information with other information, thus causing damage or control to the remote drone. Additionally, VPN technology would not necessarily protect the connection either, if the ground station computer were compromised, thus allowing an intruder access inside the secure network.

The control of the drone can be secured using standards based technology by building an SSL/TLS (Secure Sockets Layer/Trusted Layer Security) connection between both sides (i.e. the ground control and the drone), in a bi-directional setup, otherwise known as a 2 Way SSL/TLS connection. Each SSL/TLS connection requires server and client certificates to be created, usually these are just randomly created by the server computer and then assigned to the remote computer. This is done routinely, as anyone accessing an HTTPS website would be getting a ONE-WAY SSL/TLS connection, which means that the remote server provided a certificate to the client device that can be used to verify the identity of the remote server and secure the data link so traffic is protected from point A to point B. However, this one way connection does not provide identity of the client device, or who owns it, or who is controlling it to the server. The proposed method, binds a biometric identifier of the owner or operator of the drone system, to the certificate created for the drone, and subsequently embedded inside that drone's onboard computer. The onboard computer may have basic TCP/IP functionality, such as a Linux operating system or any system capable of using HTTPS/2 functions. In this fashion, when a remote drone connects to the control server side system, its 2 ways SSL/TLS certificates would protect the data link layer, and also provide identity of the drone system itself, announcing that a specific drone is connecting on this secure link.

Furthermore, the server side would then ask the drone owner/operator to authenticate using some remote application, i.e., a mobile phone application, which would request their biometric modality used to create the certificate itself, and if the fingerprint, face or some other biometric method was verified, it would approve and validate communications across the secure link. This method could then be used for provisioning a drone into a fleet, de-provisioning a drone from the fleet, allowing a drone to start a flight mission, or any other instance where you want to ensure that drone operations are secure and validated.

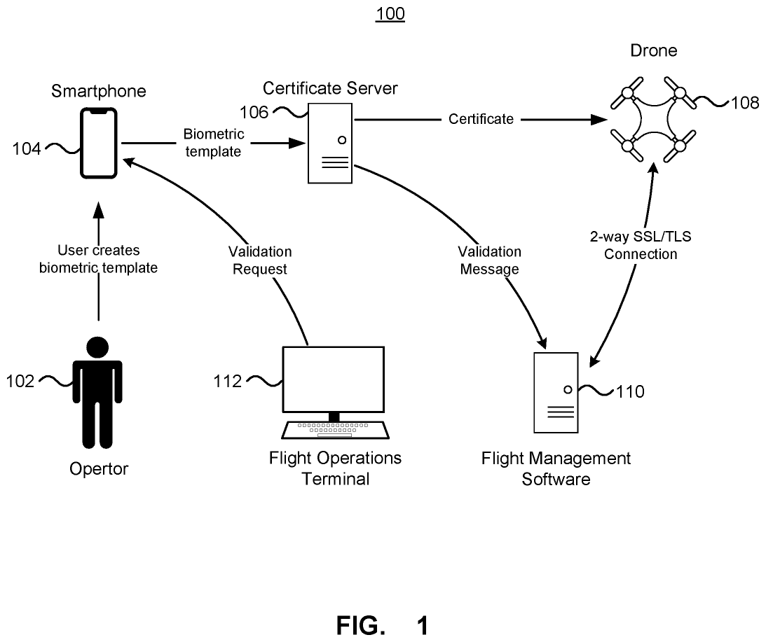

FIG. 1 depicts a drone and control system having secured communications using biometrics. The system 100 allows communication between a drone and ground control to be secured as well as ensuring the identity of the drone and ground control. Further, the system can ensure that only an authorized user or operator is able to issue certain commands to the drone or perform certain actions. As depicted a user 102 may create a biometric template using a smartphone 104 or other appropriate computing device. The smartphone 104 generates a unique biometric template of the user 102. The biometric template may be based on, for example a fingerprint, face, iris, etc. The biometric template may be transferred, for example over a wireless or wired network connection or using other communication techniques, to a certificate server 106. The certificate server may then use the biometric template as a basis for creating a unique digital certificate based on the user's biometric information in the biometric template. The digital certificate can then be provided to a new drone 108 as part of the onboarding process, embedding this certificate inside the drone's onboard computer. The digital certificate can be provided to the drone directly by the certificate server or through one or more intervening computing devices.

With the digital certificate created based on the biometric template, the drone 108 is now capable of connecting and communicating with the flight management systems 110 using this secure certificate. When the user accesses the drone in the flight operations terminal 112, a validation request may be sent to the user, or the user's device such as the smartphone 104, to validate their identity. Upon receiving the validation request, the user will validate their fingerprint or other biometric method used when creating the biometric template for the digital certificate. The certificate server 106 may then validate the request and verify that the biometric information from the user matches the certificate generated for the drone. If the match is successful, the user is granted access to control the drone, or for any operation needing authentication, such as take-off, land, go to X coordinates, the certificate server 106 sends a validation message to the Flight Management Software 110 allowing the communication to proceed. It will be appreciated that validating that the user requesting access to the drone matches the user that created the digital certificate may be performed by components other than the certificate server. For example, the flight operations terminal may request the certificate from the certificate server and determine the match of the biometrics. Accordingly, the flight control system, which may include for example the certificate server, flight operations terminal and flight management software may validate that the user requesting a certain action is authorized to perform the operation on the drone, using the user's biometric information.

A biometric template may be viewed as a set of numbers, or data representing the users face, fingerprint, iris, etc. and is processed to create the digital certificate. The use of the digital certificate created based on the user's biometric information may be used to automatically bind a user to a function, such as provisioning a drone into a fleet, or taking some action with the drone which would require secure authentication. This control system would prevent a 3rd party actor from acting maliciously, even if they had direct physical access to the flight operations terminal.

By having a certificate embedded in the drone itself, software on the flight management system would then automatically, by rules, ask for biometric validation for certain functions. In this way, without the user's own biometric, the action cannot happen, and even basic communication would be denied.

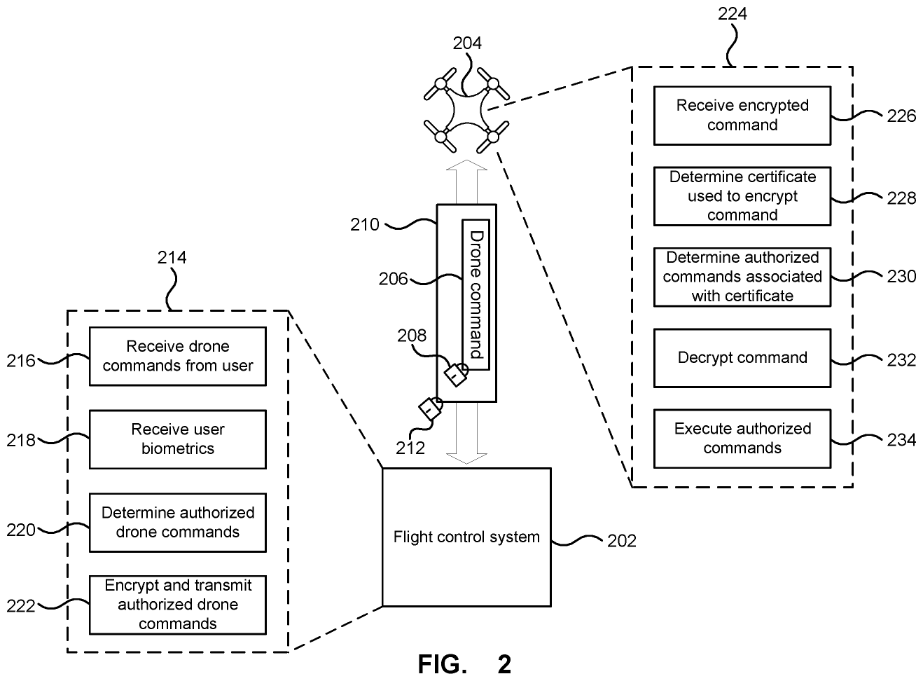

FIG. 2 depicts a communication and control method for autonomous, or semi-autonomous drones. A flight control system 202 can provide a user interface for controlling a drone or fleet of drones. For example, the interface may allow one or more different users to issue commands to a drone. The commands may include for example provisioning a drone into a fleet of drones, loading or altering a flight plan into one or more drones, executing a drone flight plan, scheduling a drone operation, downloading information from the drone, or other commands. The flight control system 202 may be provided by one or more computing devices comprising a processing unit(s) and memory unit(s). The processing unit(s) may execute instructions stored in the memory unit(s) to configure the flight control system 202 to provide various functionality, including, for example the functionality described above with regard to the certificate server, flight operations terminal, and/or the flight management software.

The flight control system 202 provides a interface for communicating with and controlling a drone 204. The drone 204 may be one drone of a plurality of drones capable of performing one or more flight operations. The drones may be stored in one or more locations, which may include remote locations, allowing the drone(s) to be used in, for example, surveying areas and/or infrastructure. As depicted, the flight control system 202 may communicate drone commands 206, or other communications, to the drone 204. The drone command may be encrypted, represented by lock 208, using a biometric based certificate associated with a user that issued the command. In addition to encrypting the command, the communication of the encrypted command may be encrypted, represented by lock 212. The communication encryption may be performed using, for example a server certificate that was previously loaded into the drone. Although depicted as being encrypted using two different certificates, it is possible to encrypt the communication and command using only one certificate. However, in such scenarios, the encryption should be provided by the user certificate so that the drone can verify that the command was issued by an authorized user. Alternatively, the communication could be encrypted using only the server certificate, however, in such scenarios, the flight control system is responsible for ensuring only those commands that are issued by a user authorized to issue that command are encrypted and transmitted by the server to the drone.

The flight control system may provide functionality 214 for controlling the drone. The functionality 214 includes receiving one or more drone commands from the user (216) and receiving biometrics from a user (218). The biometrics may be received in various ways, including for example one or more sensors attached to the flight control system. Additionally or alternatively, the flight control system may generate a biometrics request that is sent to a device associated with the user and the user device may use one or more sensors to capture the biometrics and return them to the system. The user's biometrics may used to determine if the user is authorized to issue the received commands (220). The user, or the user certificate, may be associated with one or more commands that the user is authorized to issue. Alternatively, the biometrics may first be received from the user and compared to the biometrics used in generating the certificate for the user. Assuming the biometrics match, the flight control system may present the user with one or more commands that they are authorized to issue from which the user may select one or more of the commands to issue. The authorized drone commands may then be encrypted, for example using the certificate of the user issuing the commands, and transmitted to the drone.

The drone 204 comprises one or more processing unit(s) and memory unit(s). The processing unit(s) may execute instructions stored in the memory unit(s) to configure the drone to provide functionality 224. The functionality 224 may include receiving the encrypted command (226). The command may be received either directly or indirectly for example through a drone station that the drone is located at. The certificate used to encrypt the command is determined (228). The certificate used to encrypt the command in various ways including for example using a portion of the message that was not encrypted with the command that provides an indication of the encryption certificate used, or by attempting to decrypt the command with each certificate until the command is successfully decrypted. Once the certificate used to encrypt the command is determined, the commands that are authorized for the user associated with the certificate are determined (730). The command may then be decrypted (732) and if the user of the encrypting/decrypting certificate is authorized to issue the command, the authorized command is executed (234).

Additionally or alternatively, if the user's authorization to issue commands is validated by the server, the drone may verify that the command has been sent by the server, for example using a certificate of the server. If the server is verified to have sent to the command, the drone may execute the command without verifying the user that issued the command. Applicant notes that it is possible for the user's authorization to issue command's may be verified by either the server or the drone. However, having both the server and the drone verify the user is authorized to issue commands may provide additional security against unauthorized use.

It will be apparent to persons skilled in the art that a number of variations and modifications can be made without departing from the scope of the invention. Although specific embodiments are described herein, it will be appreciated that modifications may be made to the embodiments without departing from the scope of the current teachings. Accordingly, the scope of the invention should not be limited by the specific embodiments set forth, but should be given the broadest interpretation consistent with the teachings of the description as a whole.

Each element in the embodiments of the present disclosure may be implemented as hardware, software/program, or any combination thereof. Software codes, either in its entirety or a part thereof, may be stored in a computer readable medium or memory (e.g., as a ROM, for example a non-volatile memory such as flash memory, CD ROM, DVD ROM, Blu-ray™, a semiconductor ROM, USB, or a magnetic recording medium, for example a hard disk). The program may be in the form of source code, object code, a code intermediate source and object code such as partially compiled form, or in any other form.

What is claimed is:

1. A drone system comprising:
a flight control system providing a user interface for controlling the drone system, the flight control system comprising a processor and memory storing instructions which when executed by the processor configure the system to:
receive biometric information from the user;
match the received biometric information to a previously generated user certificate, the user certificate associated with one or more actions the user is authorized to execute; and
receive from a user an indication of a desired action;
if the user is authorized to perform the desired action based on matching biometric information, encrypt the desired action and transmitting the encrypted action to a drone;
a plurality of drones, each drone comprising a processor and memory storing instructions which when executed by the processor configure the drone to:
receive an encrypted action from the flight control system;
decrypt the encrypted action using a certificate stored on the drone; and
execute the decrypted action.

2. The drone system of claim 1, wherein the certificate is a user's biometric certificate associated with authorized actions, and the drone is further configured to:
determine if the decrypted action is one of the authorized actions associated with the user's biometric certificate used to decrypt the received encrypted action.

3. The drone system of claim 1, wherein certificate used to encrypt the action is a server certificate.

4. The drone system of claim 1, wherein certificate used to encrypt the action is a user's biometric certificate.

5. The drone system of claim 4, wherein the flight control system is further configured to encrypt the transmission of the encrypted action to the drone using a server certificate.

6. The drone system of claim 1, wherein the receiving the indication of the desired action from the user comprises:
subsequent to matching the received biometric information to the previously generated user certificate, presenting to the user the one or more actions the user certificate is associated with that the user is authorized to execute; and
receiving the indication of the desired action as a user selection from the presented one or more actions.

7. The drone system of claim 1, wherein receiving the indication of the desired action from the user comprises:
receiving the indication of the desired action selected from a plurality of possible actions; and
determining if the desired action is one of the one or more actions associated with the user certificate.

8. A method for controlling a drone system, the method comprising:
receiving biometric information from the user;
matching the received biometric information to a previously generated user certificate, the user certificate associated with one or more actions the user is authorized to execute; and
receiving from a user an indication of a desired action; and
if the user is authorized to perform the desired action based on matching biometric information, encrypting the desired action and transmitting the encrypted action to a drone.

9. The method of claim 8, further comprising:
receiving the encrypted action at the drone;
decrypting the encrypted action using a certificate stored on the drone; and
executing the decrypted action.

10. The method of claim 9, wherein the certificate is a user's biometric certificate associated with authorized actions, and the method further comprises:
determining if the decrypted action is one of the authorized actions associated with the user's biometric certificate used to decrypt the received encrypted action.

11. The method of claim 9, wherein certificate used to encrypt the action is a server certificate.

12. The method of claim 9, wherein certificate used to encrypt the action is a user's biometric certificate.

13. The method of claim 12, further comprising encrypting the transmission of the encrypted action to the drone using a server certificate.

14. The method of claim 9, wherein the receiving the indication of the desired action from the user comprises:
subsequent to matching the received biometric information to the previously generated user certificate, presenting to the user the one or more actions the user certificate is associated with that the user is authorized to execute; and
receiving the indication of the desired action as a user selection from the presented one or more actions.

15. The method of claim 9, wherein receiving the indication of the desired action from the user comprises:
receiving the indication of the desired action selected from a plurality of possible actions; and
determining if the desired action is one of the one or more actions associated with the user certificate.

16. A computer readable medium having instructions stored thereon for configuring one or more computing devices to perform a method for controlling a drone system, the method comprising:
receiving biometric information from the user;
matching the received biometric information to a previously generated user certificate, the user certificate associated with one or more actions the user is authorized to execute; and
receiving from a user an indication of a desired action; and
if the user is authorized to perform the desired action based on matching biometric information, encrypting the desired action and transmitting the encrypted action to a drone.

17. The computer readable medium of claim 16, wherein the method further comprises:
receiving the encrypted action at the drone;
decrypting the encrypted action using a certificate stored on the drone; and
executing the decrypted action.

18. The computer readable medium of claim 16, wherein the certificate is a user's biometric certificate associated with authorized actions, and the method further comprises:
determining if the decrypted action is one of the authorized actions associated with the user's biometric certificate used to decrypt the received encrypted action.

19. The computer readable medium of claim 16, wherein certificate used to encrypt the action is a server certificate.

20. The computer readable medium of claim 16, wherein certificate used to encrypt the action is a user's biometric certificate.

21. The computer readable medium of claim 20, wherein the method further comprises encrypting the transmission of the encrypted action to the drone using a server certificate.

22. The computer readable medium of claim 16, wherein the receiving the indication of the desired action from the user comprises:
subsequent to matching the received biometric information to the previously generated user certificate, presenting to the user the one or more actions the user certificate is associated with that the user is authorized to execute; and
receiving the indication of the desired action as a user selection from the presented one or more actions.

23. The computer readable medium of claim 16, wherein receiving the indication of the desired action from the user comprises:
receiving the indication of the desired action selected from a plurality of possible actions; and
determining if the desired action is one of the one or more actions associated with the user certificate.
